(19) United States
(12) Patent Application Publication
(10) Pub. No.: US 2025/0148103 A1
(43) Pub. Date: May 8, 2025

(54) Secure and efficient distributed processing

(71) Applicant: Mellanox Technologies, Ltd., Yokneam (IL)

(72) Inventors: Miriam Menes, Tel Aviv (IL); Liran Liss, Atzmon-Segev (IL); Noam Bloch, Bat Shlomo (IL); Idan Borshteen, Carmiel (IL); Boris Pismenny, Chavannes pres Renens (CH); Ariel Shahar, Jerusalem (IL)

(21) Appl. No.: 19/017,665

(22) Filed: Jan. 12, 2025

Related U.S. Application Data
(63) Continuation-in-part of application No. 17/899,648, filed on Aug. 31, 2022.

(30) Foreign Application Priority Data
Dec. 14, 2021 (IL) 289002

(51) Int. Cl. G06F 21/60

(52) U.S. Cl. CPC G06F 21/606

(57) ABSTRACT

In one embodiment, a secure distributed processing system includes a plurality of nodes connected over a network, and configured to process a plurality of tasks, each one of the nodes including a processor to process task-specific data, and a network interface controller (NIC) to connect to other ones of the nodes over the network, compute task-and-node-specific communication keys for securing communication with ones of the nodes over the network based on task-specific master keys and node-specific data, and securely communicate the processed task-specific data with the ones of the nodes over the network based on the task-and-node-specific communication keys.

### RELATED APPLICATION INFORMATION

The present application is a continuation-in-part of U.S. patent application Ser. No. 17/899,648 of Menes, et al., entitled “Secure and efficient distributed processing” and filed on Aug. 31, 2022, which claims priority from Israel Patent Application 289,002 filed on Dec. 14, 2021, the disclosures of which are hereby incorporated herein by reference.

### FIELD OF THE DISCLOSURE

The present disclosure relates to computer systems, and in particular, but not exclusively to, secure distributed processing.

### BACKGROUND

In some computer systems, processors (e.g., central processing units (CPUs) and/or graphics processing units (GPUs)) in different respective processing nodes may collaborate under the orchestration of a centralized entity, for example, to perform processing tasks such that one part of a processing task is performed by one processor in one processing node, and another part of the processing task is performed by another processor in another processing node, and so on. Parallelizing a computing task among multiple nodes helps to reduce task execution time, and enables execution of large computing tasks in reasonable run times.

The processing nodes may be connected via a wired and/or wireless network and may process one or more processing tasks simultaneously, or at different times. Data processed by one of the processing nodes may be passed to one or more other processing nodes for further processing. The data passed between processing nodes may be secured.

U.S. Pat. No. 9,110,860 to Shahar describes a computing method including accepting a notification of a computing task for execution by a group of compute nodes interconnected by a communication network, which has a given interconnection topology and includes network switching elements. A set of preferred paths, which connect the compute nodes in the group via at least a subset of the network switching elements to one or more root switching elements, are identified in the communication network based on the given interconnection topology and on a criterion derived from the computing task. The network switching elements in the subset are configured to forward node-level results of the computing task produced by the compute nodes in the group to the root switching elements over the preferred paths, so as to cause the root switching elements to calculate and output an end result of the computing task based on the node-level results.

U.S. Pat. No. 8,250,556 to Lee, et al., describes a system comprising a plurality of computation units interconnected by an interconnection network. A method for configuring the system comprises receiving an initial partitioning of instructions into initial subsets corresponding to different portions of a program; forming a refined partitioning of the instructions into refined subsets each including one or more of the initial subsets, including determining whether to combine a first subset and a second subset to form a third subset according to a comparison of a communication cost between the first subset and second subset and a load cost of the third subset that is based at least in part on a number of instructions issued per cycle by a computation unit; and assigning each refined subset of instructions to one of the computation units for execution on the assigned computation unit.

### SUMMARY

There is provided in accordance with still another embodiment of the present disclosure, a secure distributed processing system, including a plurality of nodes connected over a network, and configured to process a plurality of tasks, each one of the nodes including a processor to process task-specific data, and a network interface controller (NIC) to connect to other ones of the nodes over the network, compute task-and-node-specific communication keys for securing communication with ones of the nodes over the network based on task-specific master keys and node-specific data, and securely communicate the processed task-specific data with the ones of the nodes over the network based on the task-and-node-specific communication keys.

Further in accordance with an embodiment of the present disclosure the NIC is to compute task-and-node-pair-specific communication keys based on node-pair specific data, and securely communicate the processed task-specific data with the ones of the nodes over the network based on the task-and-node-pair-specific communication keys.

Still further in accordance with an embodiment of the present disclosure the node-pair specific data is based on address information of a pair of the nodes.

Additionally in accordance with an embodiment of the present disclosure the NIC is to secure communication of the task-specific data based on at least one of different initialization vectors (IVs) for different packets.

Moreover, in accordance with an embodiment of the present disclosure the different IVs are based on values of a counter or a timer.

Further in accordance with an embodiment of the present disclosure, the system includes an orchestration node to trigger use of secondary task-specific master keys by the nodes upon one of the nodes recovering from failure.

Still further in accordance with an embodiment of the present disclosure the orchestration node is to designate the secondary task-specific master keys as primary task-specific master keys and provide new secondary task-specific master keys to the nodes.

Additionally in accordance with an embodiment of the present disclosure, the system includes an orchestration node to trigger use of secondary task-specific master keys by the nodes upon one of the nodes depleting initialization vector space.

Moreover, in accordance with an embodiment of the present disclosure the orchestration node is to designate the secondary task-specific master keys as primary task-specific master keys and provide new secondary task-specific master keys to the nodes.

Further in accordance with an embodiment of the present disclosure the NIC is to compute task-and-node-specific communication keys based on the task-specific master keys and a generation indicator.

Still further in accordance with an embodiment of the present disclosure, the system includes an orchestration node to track the generation indicator of each of the nodes, and advance a value of the generation indicator of a given node of the nodes that recovered from failure, wherein the given node is to inform respective ones of the nodes about the value of the generation indicator of the given node.

Additionally in accordance with an embodiment of the present disclosure the NIC of a sender node of the nodes is to compute the task-and-node-specific communication keys based on the task-specific master keys and based on data that identifies the sender node, and the NIC of a receiver node of the nodes is to receive encrypted data from the NIC of the sender node, compute a decryption key based on a given one of the task master keys and the data that identifies the sender node, and decrypt the encrypted data based on the decryption key.

Moreover, in accordance with an embodiment of the present disclosure the data that identifies the sender node includes sender address information.

Further in accordance with an embodiment of the present disclosure the NIC of the sender node is to secure communication of the task-specific data based on at least one of different initialization vectors (IVs) for different packets.

Still further in accordance with an embodiment of the present disclosure the NIC of the receiver node is to receive an initialization vector from the sender node, and decrypt the encrypted data based on the decryption key and the received initialization vector.

Additionally in accordance with an embodiment of the present disclosure the different IVs are based on values of a counter or a timer.

There is also provided in accordance with another embodiment of the present disclosure, a secure distributed processing method, including processing task-specific data, connecting to other ones of a plurality of nodes over a network, computing task-and-node-specific communication keys for securing communication with ones of the nodes over the network based on task-specific master keys and node-specific data, and securely communicating the processed task-specific data with the ones of the nodes over the network based on the task-and-node-specific communication keys.

Moreover, in accordance with an embodiment of the present disclosure the securely communicating is based on at least one of different initialization vectors (IVs) for different packets.

Further in accordance with an embodiment of the present disclosure, the method includes triggering use of secondary task-specific master keys by the nodes upon one of the nodes recovering from failure.

Still further in accordance with an embodiment of the present disclosure, the method includes designating the secondary task-specific master keys as primary task-specific master keys, and providing new secondary task-specific master keys to the nodes.

Additionally in accordance with an embodiment of the present disclosure, the method includes triggering use of secondary task-specific master keys by the nodes upon one of the nodes depleting initialization vector space.

Moreover, in accordance with an embodiment of the present disclosure, the method includes designating the secondary task-specific master keys as primary task-specific master keys, and providing new secondary task-specific master keys to the nodes.

Further in accordance with an embodiment of the present disclosure the computing includes computing task-and-node-specific communication keys based on the task-specific master keys and a generation indicator.

Still further in accordance with an embodiment of the present disclosure, the method includes tracking the generation indicator of each of the nodes, advancing a value of the generation indicator of a given node that recovered from failure, and informing respective ones of the nodes about the value of the generation indicator of the given node.

Additionally in accordance with an embodiment of the present disclosure the computing includes computing the task-and-node-specific communication keys based on the task-specific master keys and based on data that identifies a sender node, receiving encrypted data from the sender node, computing a decryption key based on a given one of the task master keys and the data that identifies the sender node, and decrypting the encrypted data based on the decryption key.

### BRIEF DESCRIPTION OF THE DRAWINGS

The present disclosure will be understood from the following detailed description, taken in conjunction with the drawings in which:

FIG. 1 is a block diagram view of a secure distributed processing system constructed and operative in accordance with an embodiment of the present invention;

FIG. 2 is a flowchart including steps in a method of operation of the system of FIG. 1;

FIG. 3 is a process and information-flow flowchart for a method of operation of two nodes in the system of FIG. 1;

FIG. 4 is a flowchart including steps for a method of operation of a node in the system of FIG. 1;

FIG. 5 is a flowchart including steps in a method of hardware resource reservation in the system of FIG. 1;

FIG. 6 is a flowchart including steps in an alternative method of the system of FIG. 1;

FIG. 7 is a flowchart including steps in a method to trigger use of new task-specific master keys in the system of FIG. 1;

FIG. 8 is a flowchart including steps in a method to trigger use of a new generation number in the system of FIG. 1;

FIG. 9 is a flowchart including steps in a method of operation of a receiver device in the system of FIG. 1; and

FIG. 10 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

High performance processing applications may be characterized by jobs or tasks being divided among multiple servers or processing nodes which process the jobs or tasks in a distributed manner. The processing nodes communicate with each other during the duration of a job or task. The communication is generally not one-to-one, but many-to-many or all-to-all among the nodes. Processing a task may involve thousands, or tens of thousands of connections. In order to communicate securely, the data exchange between the nodes is generally encrypted using a suitable key or keys.

If the same key is used by all the nodes, then security would be poor as the key may be found using known attacks. If different keys are used between different node-pairs, for example, using a secure key sharing algorithm, such as Diffie Hellman, then establishing cryptographic keys between each pair of nodes would require a large amount of memory, complexity, and processing time. For example, since every secure connection includes a state, communicating with N end nodes would require a processing node to hold 2N states using a large amount of memory.

Therefore, embodiments of the present invention solve the above problems by offloading data security to the processing nodes. A master key is securely distributed to each of the processing nodes for each task or job. Therefore, each processing node receives and stores a set of task master keys, with one master key for each task. When a node needs to communicate with another node, for a given task, a task and node-pair specific communication key is computed by each node based on the master key for the given task and other node-pair specific data. The key is specific for the given task and data of the node pair. The node-pair specific data may include a key identifier (e.g., key index) generated by one of the nodes in the communicating node pair and/or based on address information of the node pair. The node-pair may then securely communicate using the computed task and node-pair specific communication key. Once the communication between the node pair is complete, the computed key is discarded. New communications for the same node pair or different node pairs generally result in new respective task and node-pair specific communication keys being computed by the respective node pairs.

For example, node A may send a request to node B to securely communicate for a given task. The request may include an index of the master key for the given task or an identity of the given task. Node B may then generate a unique key identifier (e.g., key index) and responds to the request with the key identifier (e.g., key index). Node A and node B may then compute the task and node-pair specific communication key based on the master key of the given task and the generated key identifier (e.g., key index), and optionally address information of node A and/or node B. Node A may then encrypt data for the given task using the computed task and node-pair specific communication key. The data is sent to node B, which decrypts the data using the computed task and node-pair specific communication key for the given task.

InfiniBand (IB) uses Dynamic Connections (DC) to dynamically connect node pairs using less resources than static connections (e.g., InfiniBand Reliable Connections) and associating a hardware resource to a DC connection. When a dynamic connection is established, there is a short handshake including a request and acknowledgment. When the connection is finished, the hardware resource is released for use by another connection. In addition to setting up a connection between a node pair, the DC mechanism may be extended to pass a newly generated unique key identifier (e.g., key index) per dynamic connection and thereby enable the node pairs to generate a task and node-pair specific communication key per dynamic connection. As the communication key is refreshed per dynamic connection, the key is protected against replay attacks and therefore information normally needed to be saved in the cryptographic state to prevent replay attacks is not needed. In fact, the cryptographic state may be cleared every connection thereby reducing the state data that needs to be stored by the nodes. IB DC allows holding a connection state for connections only while the nodes are transferring data. Embodiments of the present invention allow the nodes to hold the cryptographic state together with the IB-DC state for each active connection.

Embodiments of the present invention may be implemented without using IB DC. For example, other dynamic-type connections may be used, or static connections may be used. In some embodiments, multiple connections (e.g., non IB DC connections) in the same security domain may share keys.

Using the same task and node-pair specific communication key between nodes may allow the encryption scheme to be attacked and broken. Therefore, embodiments described above use unique key identifiers for each communication (e.g., connection) between the node-pair to mitigate such an attack.

Embodiments of the present invention secure communication between the nodes by using a per-packet initialization vector (IV) to change the encryption of packets so that the encryption input is different for each packet. The IV may be based on any suitable scheme such as based on a value of a timer or counter. The timer may be a 24-hour timer, and the counter may be a nanosecond granular counter, by way of example. The IV may be combined in any suitable way with the encryption keys(s).

If a per-packet IV is used, the encryption input will be different for each packet. However, this assumes that the per-packet IV space does not deplete and that the previously used IV is remembered by the device. Therefore, if the per-packet IV space is depleted, e.g., the timer or counter wraps around, or if the IV is not remembered by the device such as when the device fails and then recovers (e.g., rejoins), there is a risk that the same IV may be used twice thereby leading to risk of attack on the encryption scheme. For example, if a 24-hour timer is used, the IVs may repeat themselves every 24 hours.

Therefore, embodiments of the present invention further secure communication between the nodes by rotating the task-specific master keys for all nodes if the IV is depleted (e.g., timer or counter wraps around), or if one of the nodes fails and later rejoins and therefore did not keep track of its current IV value.

Rotating the task-specific master keys may be triggered if the IV space is depleted. If the IV space is timer based, an orchestration node may detect the IV depletion and trigger all nodes to rotate the task-specific master keys (i.e., make the secondary task-specific master keys primary task-specific master keys) and provide new secondary task-specific master keys to the nodes for future use. If the IV space is counter based, the node in which the counter is running indicates to the orchestration node that the counter is going to wrap soon, and the orchestration node triggers the other nodes to rotate the task-specific master keys (i.e., make the secondary task-specific master keys primary task-specific master keys) and provide new secondary task-specific master keys to the nodes for future use.

When a failed node rejoins, the rejoining node indicates to the orchestration node that it has joined (or is using the secondary task-specific master keys) and the orchestration node triggers all nodes to rotate the task-specific master keys (i.e., make the secondary task-specific master keys primary task-specific master keys) and provide new secondary task-specific master keys to the nodes for future use.

Forcing a global rotation of task-specific master keys may be too harsh, for example, in a large enough system where nodes may fail frequently. Therefore, embodiments of the present invention use a generation number as part of the key derivation algorithm so that the generation number for a given node may be advanced if that node fails and later rejoins so as not to require rotating the task-specific master keys for all nodes. For example, the key derivation algorithm may be based on the task-specific master key, node-specific information (e.g., node-pair specific or sender-node specific information such as address information), and a generation number (e.g., one or two bits).

The orchestration node may track the generation number for the current task-specific master keys for each node. Upon master-key rolling (i.e., to new task-specific master keys), the orchestration node may trigger the generation number to be reset for all nodes. If a node fails and rejoins, the orchestration node may provide the recovered node the generation number to use (after advancing the value of the generation number previously used by the node by 1) in addition to the current task-specific master keys, and address information. The rejoining node generally informs other nodes about the generation number it is using (e.g., during handshake or in packet headers).

In some of the embodiments disclosed above, a unique key identifier is generated by the receiver and therefore a handshake is needed before any communication. Embodiments of the present invention may secure communication between the nodes by using sender-based key derivation based on details of the sender (and not of the receiver) and without the need to use a receiver generated unique key identifier. If the sender uses a different IV for every destination that it is sending a packet to (and optionally a different IV for each packet), e.g., based on a new timer value or a new counter value, then the task-and-node-specific communication key may be based on the details of the sender such as sender address information without needing to use receiver information. The derivation-function for a task-and-node-specific communication key may be based on the task-specific master key, and the sender address. The packets may be encrypted based on the task-and-node-specific communication key and respective different IVs, for example. The receiver may compute the task-and-node-specific communication key based on the above sender details, and decrypt the received packets based on the computed task-and-node-specific communication key and the respective IVs received in the respective packets. The receiver does not use sender information to send packets. When the receiver sends packets, the receiver is a sender and behaves accordingly.

### SYSTEM DESCRIPTION

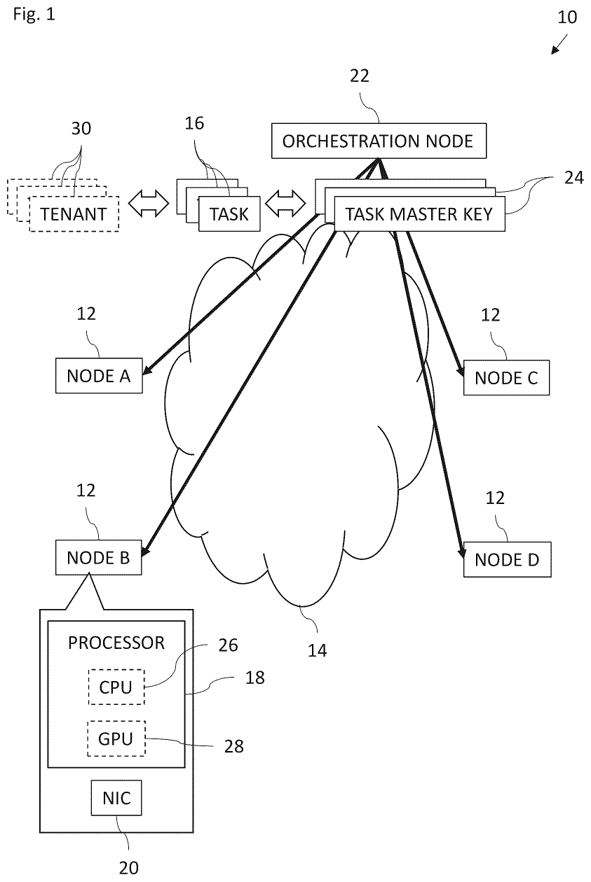

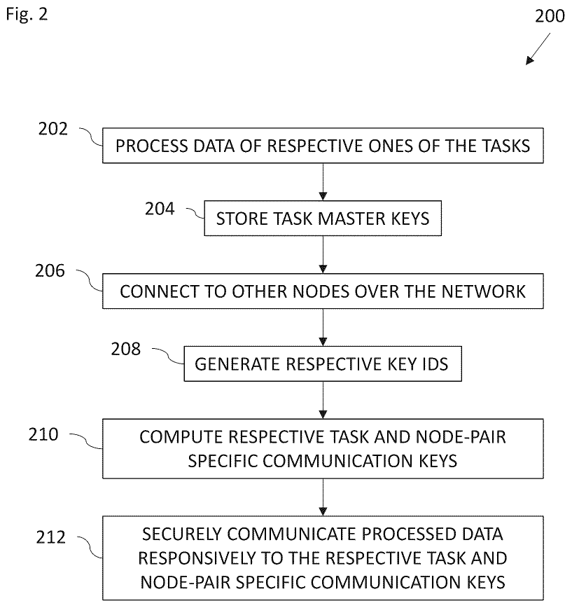

Reference is now made to FIG. 1, which is a block diagram view of a secure distributed processing system 10 constructed and operative in accordance with an embodiment of the present invention. The secure distributed processing system 10 includes a plurality of nodes 12 (only 4 shown for the sake of simplicity) connected over a network 14, and configured to process a plurality of tasks 16. In some embodiments, each task 16 may be processed as a respective distributed process by more than one of the nodes 12. Each node 12 includes a processor 18 to process data of respective ones of the tasks 16 and a network interface controller 20 (NIC) described in more detail with reference to FIGS. 2-5. The processor 18 may include a CPU 26 and/or a GPU 28.

The secure distributed processing system 10 includes an orchestration node 22, which generates respective task master keys 24 for the tasks 16 and distributes the task master keys 24 to each of the nodes 12.

In some embodiments, tasks 16 may be performed for tenants 30. For example, the nodes 12 may process data for different tenants 30, e.g., different corporations, which rent processing space in the secure distributed processing system 10 such that each node 12 may process data for different tenants 30 at the same or different times. One of the tasks 16 may represent one, some, or all, of the processes performed for a respective tenant 30. In other words, in some embodiments, all processes of a given tenant may be classified as the same task or job. For one of the nodes 12, the GPU 28 and/or the CPU 26 of that node 12 is configured to process data of respective ones of the tasks 16 for respective ones of the tenants 30.

In practice, some or all of the functions of the processor 18 may be combined in a single physical component or, alternatively, implemented using multiple physical components. These physical components may comprise hard-wired or programmable devices, or a combination of the two. In some embodiments, at least some of the functions of the processor 18 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Graphics processing units (GPUs) are employed to generate three-dimensional (3D) graphics objects and two-dimensional (2D) graphics objects for a variety of applications, including feature films, computer games, virtual reality (VR) and augmented reality (AR) experiences, mechanical design, and/or the like. A modern GPU includes texture processing hardware to generate the surface appearance, referred to herein as the “surface texture,” for 3D objects in a 3D graphics scene. The texture processing hardware applies the surface appearance to a 3D object by “wrapping” the appropriate surface texture around the 3D object. This process of generating and applying surface textures to 3D objects results in a highly realistic appearance for those 3D objects in the 3D graphics scene.

The texture processing hardware is configured to perform a variety of texture-related instructions, including texture operations and texture loads. The texture processing hardware generates accesses texture information by generating memory references, referred to herein as “queries,” to a texture memory. The texture processing hardware retrieves surface texture information from the texture memory under varying circumstances, such as while rendering object surfaces in a 3D graphics scene for display on a display device, while rendering 2D graphics scene, or during compute operations.

Surface texture information includes texture elements (referred to herein as “texels”) used to texture or shade object surfaces in a 3D graphics scene. The texture processing hardware and associated texture cache are optimized for efficient, high throughput read-only access to support the high demand for texture information during graphics rendering, with little or no support for write operations. Further, the texture processing hardware includes specialized functional units to perform various texture operations, such as level of detail (LOD) computation, texture sampling, and texture filtering.

In general, a texture operation involves querying multiple texels around a particular point of interest in 3D space, and then performing various filtering and interpolation operations to determine a final color at the point of interest. By contrast, a texture load typically queries a single texel, and returns that directly to the user application for further processing. Because filtering and interpolating operations typically involve querying four or more texels per processing thread, the texture processing hardware is conventionally built to accommodate generating multiple queries per thread. For example, the texture processing hardware could be built to accommodate up to four texture memory queries is performed in a single memory cycle. In that manner, the texture processing hardware is able to query and receive most or all of the needed texture information in one memory cycle.

Reference is now made to FIG. 2, which is a flowchart 200 including steps in method of operation of the system 10 of FIG. 1. The method described with reference to FIG. 2 is described for one of the nodes 12, and the processor 18 and the network interface controller 20 for that node 12.

The processor 18 is configured to process (block 202) data of respective ones of the tasks 16. The network interface controller 20 is configured to store (block 204) the task master keys 24 for use in computing communication keys for securing data transfer over the network 14 for respective ones of the tasks 16. The network interface controller 20 is configured to connect (block 206) to other nodes 12 over the network 14.

In some embodiments, the network interface controller 20 of a respective one of the nodes in each of the respective node pairs trying to set up respective connections is configured to generate (block 208) respective unique key identifiers (e.g., key indices) (for each received connection request). For example, for a first connection between a first node pair, one of the nodes in the first node-pair generates a first key identifier, and for a second connection between a second node pair, one of the nodes in the first node-pair generates a second key identifier, and so on.

The network interface controller 20 is configured to compute (block 210) respective task and node-pair specific communication keys for securing communication with respective ones of the nodes 12 over the network 14 for respective ones of the tasks 16 responsively to respective ones of the task master keys 24 and node-specific data of respective pairs of the nodes. For example, the task and node-pair specific communication keys are computed by inputting respective ones of the task master keys 24 and node-specific data of respective pairs of the nodes into a suitable key computation function or algorithm. The node-specific data of each of the respective pairs of the nodes 12 may include the respective key identifiers (e.g., key indices) and/or respective node-pair address information). The task and node-pair specific communication keys may be computed using any suitable algorithm, for example, HMAC-SHA, or CMAC.

For example, for task X between nodes A and B, the task and node-pair specific communication key is computed using the master key for task X and node-specific data of nodes A and B (e.g., including a key identifier generated by node A or B), and for task Y between nodes C and B, the task and node-pair specific communication key is computed using the master key for task Y and node-specific data of nodes C and B (e.g., including a key identifier generated by node C or B).

By way of another example, node A may send a request to node B to securely communicate for a given task. The request may include an index of the master key for the given task or an identity of the given task. Node B may then generate a unique key identifier and respond to the request with the key identifier. Node A and node B may then compute the task and node-pair specific communication key based on the master key of the given task and the generated key identifier, and optionally address information of node A and/or node B.

In some embodiments, the network interface controller 20 is configured to compute the task and node-pair specific communication keys responsively to setting up new connections with other nodes 12 over the network 14 so that for each new connection with a respective one of the nodes 12 the network interface controller 20 is configured to compute a corresponding new task and node-pair specific communication key.

The network interface controller 20 is configured to securely communicate (block 212) the processed data of tasks 16 (or data processed by other nodes 12) with respective ones of the nodes 12 over the network 14 responsively to the respective task and node-pair specific communication keys. For example, a task and node-pair specific communication key A is used for communicating with node A for a given task, and task and node-pair specific communication key B is used for communicating with node B for the given task or a different task. By way of another example, node A may encrypt data for the given task using the computed task and node-pair specific communication key. The data is sent to node B, which decrypts the data using the computed task and node-pair specific communication key for the given task.

In some embodiments, the cryptographic state history does not need to be saved. The cryptographic state may include a replay window, which may include data for the current connection, but it is does not need to include any historical data. The cryptographic state may hold the generated key identifier, a pointer to task master key, and a replay window that has been reset.

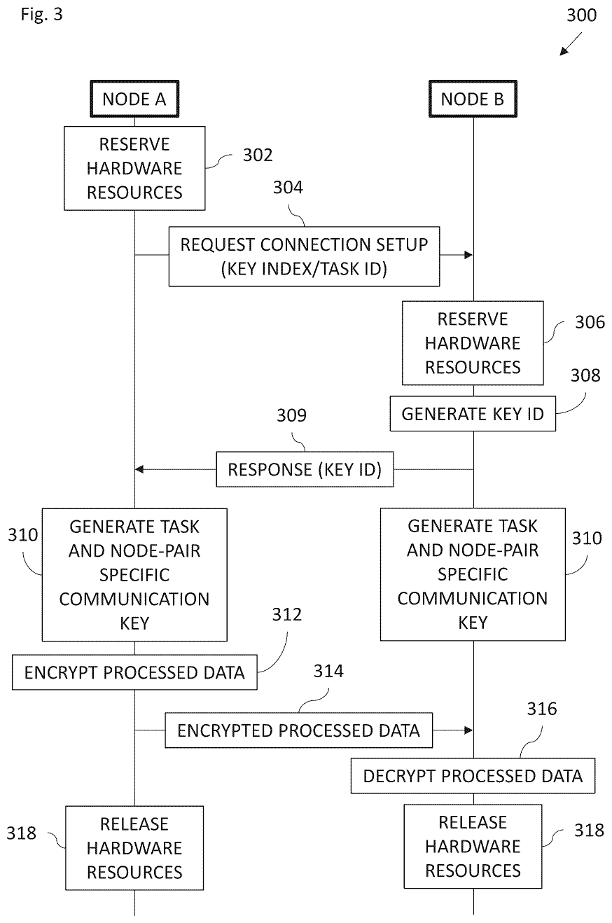

Reference is now made to FIG. 3, which is a process and information-flow flowchart 300 including steps in a method of operation of two nodes in the system 10 of FIG. 1. FIGS. 3 shows processes performed by a node pair including node A and node B and data passed between node A and node B.

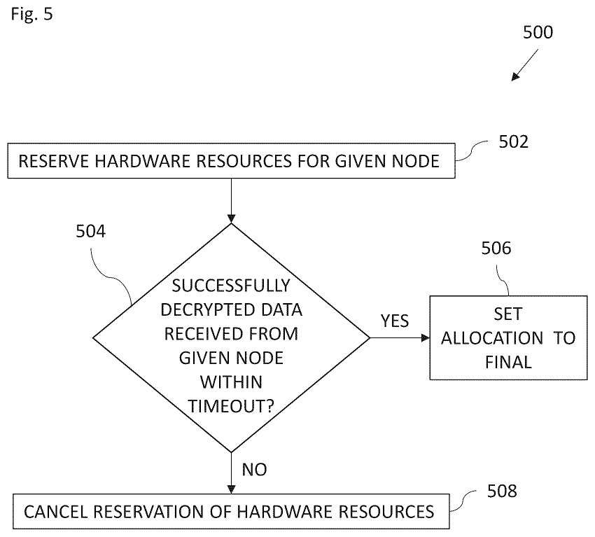

Node A is processing data for a task X. Node A reserves (block 302) hardware resources in its network interface controller 20 to set up a connection (e.g., an IB DC connection) and may optionally set up a state (e.g., a IB DC state) to handle the connection. Node A sends (block 304) a connection request to node B. The connection request includes an index to the task master key 24 relevant to task X or an identification (ID) of task X. Node B receives the request and reserves (block 306) hardware resources in its network interface controller 20 to support the requested connection and may optionally set up a state (e.g., a IB DC state) to handle the connection. Node B may release the reserved hardware resources if node A does not send relevant data within a given timeout, described in more detail with reference to FIG. 5. Node B generates (block 308) a key identifier. Node B responds (block 309) to node A with the generated key identifier. Node A and node B each generate (block 310) the same task and node-pair specific communication key based on the task master key 24 for task X, the generate key identifier, and optionally address information of node A and/or node B. Node A encrypts (block 312) processed data of task X and sends (block 314) the encrypted processed data to node B. Node B receives the encrypted processed data and decrypts (block 316) the processed data. Once the communication between the nodes is completed, e.g., based on a notification from node A or node B or after a timeout of no communication, node A and node B release (block 318) the hardware resources.

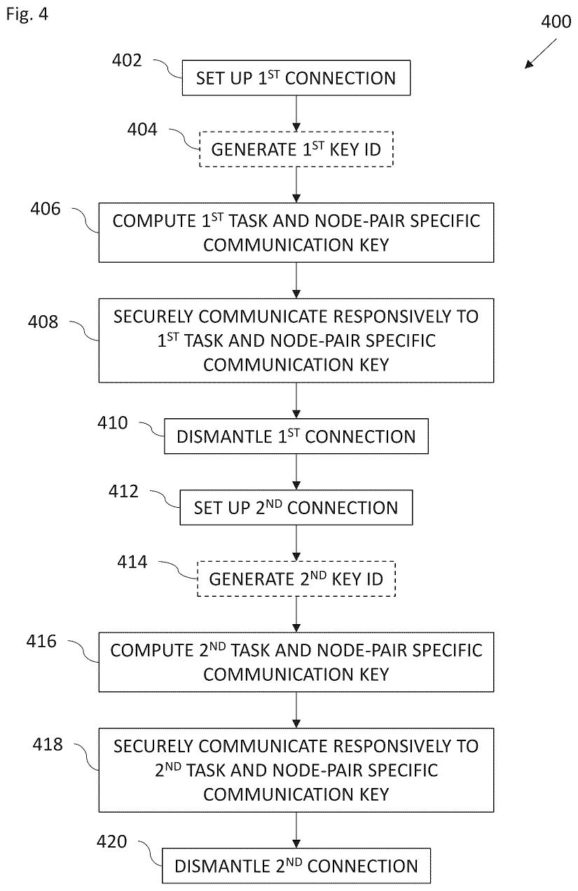

Reference is now made to FIG. 4, which is a flowchart 400 including steps for a method of operation of a node 12 in the system 10 of FIG. 1. FIG. 4 describes one node setting up and dismantling two connections. The two connections may be active at the same time or at different times. The two connections may be for the same node pair or different node pairs.

The network interface controller 20 is configured to set up (block 402) a first connection (e.g., reserve hardware resources and set up a state) with a given one of the nodes 12, optionally generate (block 404) a first key identifier (optionally responsively to a first connection request from the given node 12) or receive the first key identifier from the given node 12, compute (block 406) a first task and node-pair specific communication key for the first connection responsively to the first key identifier and/or address information of the node pair and the master key for the first task, securely communicate (block 408) with the given node 12 responsively to the first task and node-pair specific communication key, and dismantle (block 410) the first connection once communication is completed.

The network interface controller 20 is configured to set up (block 412) a second connection (e.g., reserve hardware resources and set up a state) with a given one of the nodes 12, optionally generate (block 414) a second key identifier (responsively to a second connection request from the given node 12) or receive the second key identifier from the given node 12, compute (block 416) a second task and node-pair specific communication key for the second connection responsively to the second key identifier (different to the first key identifier) and/or address information of the node pair and the master key for the second task, securely communicate (block 418) with the given node 12 responsively to the second task and node-pair specific communication key, and dismantle (block 420) the second connection once communication is completed.

Securely communicating may include one of the nodes encrypting data to send to the other node in the node pair for decryption (e.g., one-way secure communication), or both nodes encrypting data to send to each other for decryption by the other node in the pair (e.g., two-way secure communication).

Reference is now made to FIG. 5, which is a flowchart 500 including steps in a method of hardware resource reservation in the system 10 of FIG. 1.

In some embodiments, a timeout may be used to prevent connections being set up and reserving resources without communication commencing. In this way, denial of service attacks may be prevented by an attacker who does not have access to the task master keys 24. Therefore, if communication does not start by the end of a timeout, the connection is dismantled, and hardware resources are released.

Therefore, the network interface controller 20 of node A is configured to reserve (block 502) hardware resources responsively to a request from node B to establish a connection with node A. At a decision block 504, the network interface controller 20 of node A is configured to check if data has been received from node B and that data has been successfully decrypted within a given timeout. If data has been received from node B and successfully decrypted, with the given timeout, the network interface controller 20 is configured to set the allocation of the connection resources to final (block 506) (i.e., without further checking the timeout). Responsively to not successfully decrypting data received from node B within the given timeout, the network interface controller 20 is configured to cancel reservation of the reserved hardware resources (block 508).

In other embodiments, a timeout is not implemented with respect to reserving resources and resource management may be handled in any suitable manner.

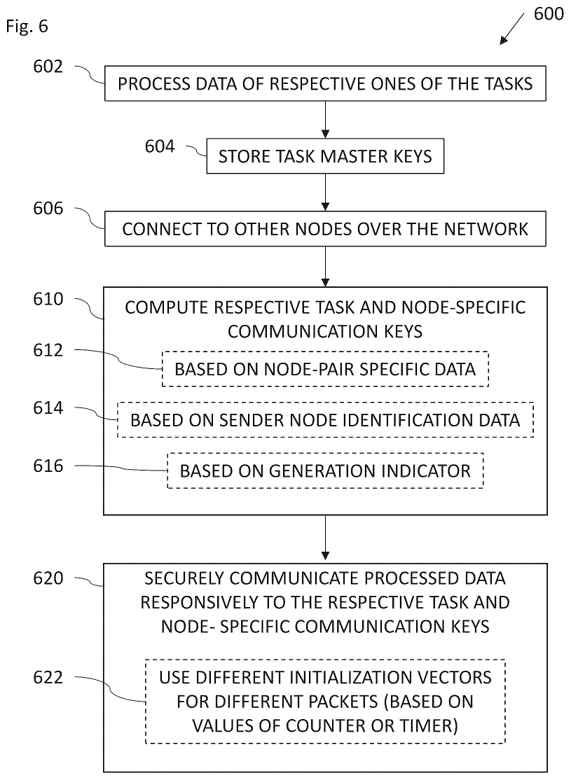

Reference is now made to FIG. 6, which is a flowchart 600 including steps in an alternative method of the system 10 of FIG. 1. The following steps may be performed by of any of the nodes 12. The processor 18 is configured to process task-specific data of respective ones of the tasks (block 602).

The network interface controller 20 is configured to store task- specific master keys for different tasks (block 604). The stored keys may include primary task-specific master keys and secondary task-specific master keys. The primary task-specific master keys are the keys currently used in key material generation, and the secondary task-specific master keys are spare keys waiting to be used if a decision is made not to use the primary task-specific master keys, in which case the secondary task-specific master keys become the new primary task-specific master keys, and new secondary task-specific master keys are provided by the orchestration node 22 to the nodes 12.

The network interface controller 20 is configured to connect to other ones of the nodes 12 over the network 14 (block 606). In some embodiments, initialization vectors (IVs) are typically used to ensure data of different packets is encrypted based on different IVs, as described in more detail below.

The network interface controller 20 is configured to compute task-and-node-specific communication keys for securing communication with one or more of the nodes 12 over the network 14 based on task-specific master keys and node-specific data (block 610). The term “node-specific” may be indicative of a single node or a node-pair, for example. In some embodiments, the network interface controller 20 is configured to compute the task-and-node-pair-specific communication keys based on node-pair specific data (i.e., based on specific data of the sender and receiver node 12) (block 612). The node-pair specific data may be derived from address information of a pair of the nodes. In some embodiments, the network interface controller 20 (i.e., of the sender node 12) is configured to compute the task-and-node-pair-specific communication keys based on the task-specific master keys and based on data that identifies the sender node 12 such as data including address information of the sender node 12 (block 614).

In some embodiments, the network interface controller 20 is configured to compute the task-and-node-specific communication keys based on the node or node-pair specific data, the task-specific master keys, and a generation indicator (block 616), described in more detail with reference to FIG. 8.

For example, the task and node-specific communication keys are computed by inputting respective ones of the task master keys 24 and node-specific data (of respective pairs of the nodes) and optionally a generation indicator into a suitable key computation function or algorithm. The task and node-specific communication keys may be computed using any suitable algorithm, for example, HMAC-SHA, or CMAC. For example, for task X between nodes A and B, the task and node-specific communication key is computed using the master key for task X and node-specific data of nodes A and B, optionally a generation indicator, and for task Y between nodes C and B, the task and node-specific communication key is computed using the master key for task Y and node-specific data of nodes C and B, optionally including a generation indicator.

The network interface controller 20 is configured to securely communicate the processed task-specific data with the ones of the nodes 12 over the network 14 based on the task-and-node-specific communication keys (block 620) and optionally based on using different initialization vectors (IVs) for different packets. For example, the network interface controller 20 of node A securely communicates processed task-specific data for task X to node B using the node-specific communication key computed using the master key for task X and node-specific data of node A. When the task-and-node-specific communication keys are computed based on sender node data (and not based on received node data), the network interface controller 20 NIC (e.g. of the sender node) is configured to secure communication of the task-specific data based on different initialization vectors (IVs) for different packets (block 622). The values selected for use as the IVs may be based on values of one or more timers and/or counters. The timer may be a 24-hour timer, and the counter may be a nanosecond granular counter, by way of example.

In some embodiments, network interface controller 20 is configured to securely communicate the processed task-specific data with the ones of the nodes 12 over the network 14 based on the task-and-node-pair-specific communication keys and optionally based on using different initialization vectors (IVs) for different packets. For example, the network interface controller 20 of node A securely communicates processed task-specific data for task X to node B using the node-specific communication key computed using the master key for task X and node-specific data of nodes A and B.

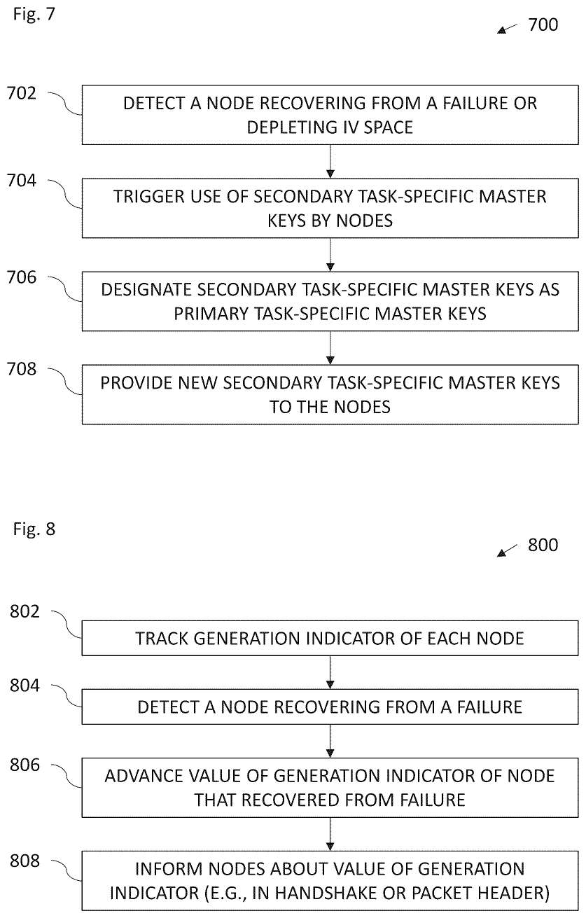

Reference is now made to FIG. 7, which is a flowchart 700 including steps in a method to trigger use of new task-specific master keys in the system 10 of FIG. 1. If a per-packet IV is used, the encryption input will be different for each packet. However, this assumes that the per-packet IV space does not deplete and that the previously used IV is remembered by the device. Therefore, if the per-packet IV space is depleted, e.g., the timer or counter wraps around, or if the IV is not remembered by the device such as when the device fails and then recovers (e.g., rejoins), there is a risk that the same IV may be used twice thereby leading to risk of attack on the encryption scheme. For example, if a 24-hour timer is used, the IVs may repeat themselves every 24 hours. Therefore, embodiments of the present invention further secure communication between the nodes 12 by rotating the task-specific master keys for all nodes if the IV space is depleted (e.g., timer or counter wraps around), or if one of the nodes fails and later rejoins and therefore did not keep track of its current IV value.

Rotating the task-specific master keys may be triggered if the IV space is depleted. If the IV space is timer based, the orchestration node 22 may detect the IV depletion and trigger all nodes 12 to rotate the task-specific master keys (i.e., make the secondary task-specific master keys primary task-specific master keys) and provide new secondary task-specific master keys to the nodes 12 for future use. If the IV space is counter based, the node 12 in which the counter is running indicates to the orchestration node 22 that the counter is going to wrap soon, and the orchestration node 22 triggers all other nodes 12 to rotate the task-specific master keys (i.e., make the secondary task-specific master keys primary task-specific master keys) and provide new secondary task-specific master keys to the nodes for future use.

When a failed node 12 rejoins, the rejoining node 12 indicates to the orchestration node 22 that it has joined (or is using the secondary task-specific master keys) and the orchestration node 22 triggers all other nodes 12 to rotate the task-specific master keys (i.e., make the secondary task-specific master keys primary task-specific master keys) and provide new secondary task-specific master keys to the nodes 12 for future use.

Therefore, the orchestration node 22 may be configured to detect one of the nodes 12 recovering from failure, or depleting its initialization vector space (e.g., when counter or timer wraps around) (block 702). The orchestration node 22 may be configured to trigger use of the secondary task-specific master keys by the nodes 12 upon detecting the node recovering from failure or depleting its initialization vector space (block 704). The orchestration node 22 may be configured to designate the secondary task-specific master keys as primary task-specific master keys (block 706) and provide new secondary task-specific master keys to the nodes 12 (block 708).

Reference is now made to FIG. 8, which is a flowchart 800 including steps in a method to trigger use of a new generation number in the system 10 of FIG. 1. Forcing a global rotation of task-specific master keys may be too harsh, for example, in a large enough system where nodes 12 may fail frequently. Therefore, embodiments of the present invention use a generation number as part of the key derivation algorithm of the task-and-node-specific communication keys so that the generation number for a given node 12 may be advanced if that node 12 fails and later rejoins so as not to require rotating the task-specific master keys for all nodes 12. Generation numbers are used in a unidirectional manner from sender to receiver, whereby each node encrypts packets with its own generation number.

For example, the key derivation algorithm of one of the task-and-node-specific communication keys may be based on the task-specific master key, node-specific information (e.g., node-pair specific or sender-node specific information such as address information), and a generation number (e.g., one or two bits).

The orchestration node 22 may track the generation number for the current task-specific master keys for each node 12. Upon master-key rolling (i.e., to new task-specific master keys), the orchestration node 22 may trigger the generation number to be reset (e.g., to zero or one) for all nodes. If a node fails and rejoins, the orchestration node 22 may provide the recovered node 12 the generation number to use (after advancing the value of the generation number previously used by that node 12 by 1) in addition to the current (primary and secondary) task-specific master keys, and address information of the rejoining node 12. The rejoining node 12 may inform other nodes 12 about the generation number it is using (e.g., during handshake with the nodes 12 or in packet headers).

Therefore, the orchestration node 22 is configured to track the generation indicator of each node 12 (block 802), and detect a node recovering from a failure (e.g., by the recovering node informing the orchestration node 22 that it is rejoining) (block 804). The orchestration node 22 is configured to advance a value of the generation indicator of a given node that recovered from failure (block 806). The recovering node 12 may be configured to inform one or more of the nodes 12 (in a handshake (i.e., prior to sending a flow of packets) or in packet headers (of each packet sent) while communicating with the nodes 12) about the current value of the generation indicator of the recovering node 12 (block 808).

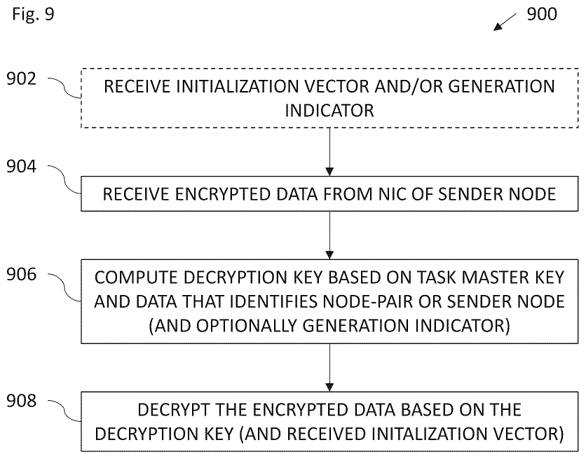

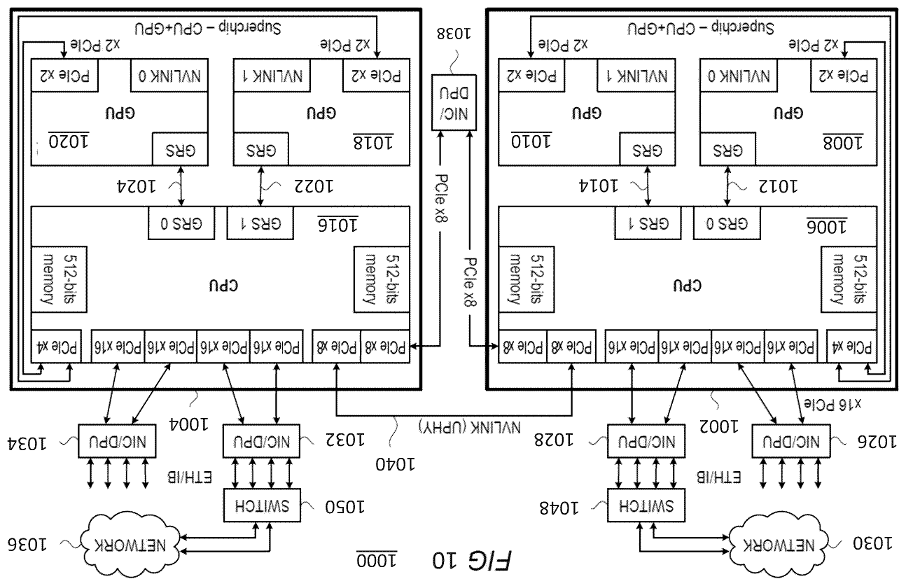

Reference is now made to FIG. 9, which is a flowchart 900 including steps in a method of operation of a receiver device (e.g., one of the nodes 12) in the system 10 of FIG. 1. In some of the embodiments disclosed above, a unique key identifier is generated by the receiver device/node and therefore a handshake is needed before any communication. Embodiments of the present invention may secure communication between the nodes 12 by using sender-based key derivation based on details of the sender node 12 (and not of the receiver node 12) and without the need to use a receiver generated unique key identifier.

If the sender node 12 uses a different IV for every destination that it is sending a packet to (and optionally a different IV for each packet), e.g., based on a new timer value or a new counter value, then the task-and-node-specific communication key may be based on the details of the sender such as sender address information without needing to use receiver information. The derivation-function for a task-and-node-specific communication key may be based on the task-specific master key, and the sender address. The packets may be encrypted based on the relevant task-and-node-specific communication keys and respective different IVs, for example.

The receiver node 12 of packet(s) may compute the task-and-node- specific communication key based on the above sender details, and decrypt the received packets based on the computed task-and-node-specific communication key and the respective IVs received in the respective packets. The receiver does not need to use sender information to send packets. When the receiver sends packets, the receiver is a sender and behaves accordingly.

Therefore, a receiver node 12 may be configured to receive from network interface controller 20 of the sender node 12: an initialization vector (and optionally a generation indicator) (block 902), e.g., in a packet header or other packet field; and encrypted data encrypted using the task-and node-specific communication key (computed by the network interface controller 20 of the sender node 12 using sender node specific details) and the initialization vector (block 904).

The receiver node 12 is configured to compute a decryption key (e.g., the task-and node-specific communication key also computed by the network interface controller 20 of the sender node 12 using sender node specific details) based on a given task master key (for the task associated with the received packet) and the data (e.g., address data) that identifies the sender node 12 and optionally a generation indicator maintained by the sender node 12 (block 906). The receiver node 12 is configured to decrypt the encrypted data based on the computed decryption key and the received initialization vector (block 908).

The device of node 12 or orchestration node 22 may be any suitable device, such as: an accelerator device; a processing device including a central processing unit (CPU) and/or a graphics processing unit (GPU); a host device connected to one or more peripheral devices; a peripheral device connected to another peripheral device and/or one or more host devices; a network device, e.g., a network interface controller (NIC) device, a data processing unit (DPU) or smart NIC including a NIC and one or more processing cores, or a network switch. One or more of the processing steps described herein may be performed by a CPU, GPU, DPU, NIC, or any suitable combination thereof.

The device(s) 12, 22 may be disposed in any suitable environment, such as a data center, for example in the computing system 1000 of FIG. 10. The data center may include cooling systems, power supply, network components such as NICs and switches and cabling to provide high-speed connectivity e.g., with multiple internet providers for redundancy, physical and cyber protections, including access controls and surveillance, organized spaces for servers and equipment. The data center may support remote storage and computing for cloud services.

Reference is now made to FIG. 10, which is a block diagram that schematically illustrates a computing system 1000, e.g., a data center or a High-Performance Computing (HPC) cluster, in accordance with an embodiment of the present disclosure.

System 1000 comprises a plurality of subsystems, e.g., multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect (e.g., Ethernet or InfiniBand), enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 10, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via a D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 10, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communicate with each other via a NIC/DPU 1038, such as over PCIe interconnects. Processing device 1002 and processing device 1004 can also communicate with each other over a high-bandwidth communication interconnect 1040, such as an NVLink interconnect or other high-speed interconnects. The packet switches in FIG. 10 may comprise, for example, Nvidia Quantum-2 switches. The

NICs/DPUs in the figure may comprise, for example, Nvidia Bluefield DPUs.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer's motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer's memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC's operation, such as speed settings, interrupt configurations, and buffer sizes; firmware/ROM that contains the embedded software that controls the NIC's operations and manages network protocols.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

The implementation of the method and/or system of examples of the disclosure can involve performing or completing selected tasks manually, automatically, or a combination thereof. Moreover, according to actual instrumentation and equipment of examples of the method and/or system of the disclosure, several selected tasks could be implemented by hardware, by software or by firmware or by a combination thereof using an operating system or a cloud-based platform.

For example, hardware for performing selected tasks according to examples of the disclosure could be implemented as a chip or a circuit. As software, selected tasks according to examples of the disclosure could be implemented as a plurality of software instructions being executed by a computer using any suitable operating system. In an exemplary example of the disclosure, one or more tasks according to exemplary examples of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed examples of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various examples of computer-implemented methods are provided herein, some of which can be performed by various examples of apparatuses and systems described herein and some of which can be performed according to instructions stored in non-transitory computer-readable storage media described herein. Still, some examples of computer-implemented methods provided herein can be performed by other apparatuses or systems and can be performed according to instructions stored in computer-readable storage media other than that described herein, as will become apparent to those having skill in the art with reference to the examples described herein. Any reference to systems and computer-readable storage media with respect to the following computer-implemented methods is provided for explanatory purposes, and is not intended to limit any of such systems and any of such non-transitory computer-readable storage media with regard to examples of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

It is appreciated that certain features of the disclosure, which are, for clarity, described in the context of separate examples, may also be provided in combination in a single example. Conversely, various features of the disclosure, which are, for brevity, described in the context of a single example, may also be provided separately or in any suitable sub-combination or as suitable in any other described example of the disclosure. Certain features described in the context of various examples are not to be considered essential features of those examples, unless the example is inoperative without those elements.

The above-described processes including portions thereof can be performed by software, hardware and combinations thereof. These processes and portions thereof can be performed by computers, computer-type devices, workstations, cloud-based platforms, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these examples to practice without undue experimentation. The processes (methods) and systems have been described in a manner sufficient to enable persons of ordinary skill in the art to readily adapt other hardware and software as may be needed to reduce any of the examples to practice without undue experimentation and using conventional techniques.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A secure distributed processing system, comprising a plurality of nodes connected over a network, and configured to process a plurality of tasks, each one of the nodes including:
a processor to process task-specific data; and
a network interface controller (NIC) to:
connect to other ones of the nodes over the network;
compute task-and-node-specific communication keys for securing communication with ones of the nodes over the network based on task- specific master keys and node-specific data; and
securely communicate the processed task-specific data with the ones of the nodes over the network based on the task-and-node-specific communication keys.

2. The system according to claim 1, wherein the NIC is to:
compute task-and-node-pair-specific communication keys based on node-pair specific data; and
securely communicate the processed task-specific data with the ones of the nodes over the network based on the task-and-node-pair-specific communication keys.

3. The system according to claim 2, wherein the node-pair specific data is based on address information of a pair of the nodes.

4. The system according to claim 1, wherein the NIC is to secure communication of the task-specific data based on at least one of different initialization vectors (IVs) for different packets.

5. The system according to claim 4, wherein the different IVs are based on values of a counter or a timer.

6. The system according to claim 4, further comprising an orchestration node to trigger use of secondary task-specific master keys by the nodes upon one of the nodes recovering from failure.

7. The system according to claim 6, wherein the orchestration node is to designate the secondary task-specific master keys as primary task-specific master keys and provide new secondary task-specific master keys to the nodes.

8. The system according to claim 4, further comprising an orchestration node to trigger use of secondary task-specific master keys by the nodes upon one of the nodes depleting initialization vector space.

9. The system according to claim 8, wherein the orchestration node is to designate the secondary task-specific master keys as primary task-specific master keys and provide new secondary task-specific master keys to the nodes.

10. The system according to claim 4, wherein the NIC is to compute task-and-node-specific communication keys based on the task-specific master keys and a generation indicator.

11. The system according to claim 10, further comprising an orchestration node to:
track the generation indicator of each of the nodes; and
advance a value of the generation indicator of a given node of the nodes that recovered from failure, wherein the given node is to inform respective ones of the nodes about the value of the generation indicator of the given node.

12. The system according to claim 1, wherein:
the NIC of a sender node of the nodes is to compute the task-and-node-specific communication keys based on the task-specific master keys and based on data that identifies the sender node; and
the NIC of a receiver node of the nodes is to:
receive encrypted data from the NIC of the sender node;
compute a decryption key based on a given one of the task master keys and the data that identifies the sender node; and
decrypt the encrypted data based on the decryption key.

13. The system according to claim 12, wherein the data that identifies the sender node includes sender address information.

14. The system according to claim 12, wherein the NIC of the sender node is to secure communication of the task-specific data based on at least one of different initialization vectors (IVs) for different packets.

15. The system according to claim 14, wherein the NIC of the receiver node is to:
receive an initialization vector from the sender node; and
decrypt the encrypted data based on the decryption key and the received initialization vector.

16. The system according to claim 14, wherein the different IVs are based on values of a counter or a timer.

17. A secure distributed processing method, comprising:
processing task-specific data;
connecting to other ones of a plurality of nodes over a network;
computing task-and-node-specific communication keys for securing communication with ones of the nodes over the network based on task-specific master keys and node-specific data; and
securely communicating the processed task-specific data with the ones of the nodes over the network based on the task-and-node-specific communication keys.

18. The method according to claim 17, wherein the securely communicating is based on at least one of different initialization vectors (IVs) for different packets.

19. The method according to claim 18, further comprising triggering use of secondary task-specific master keys by the nodes upon one of the nodes recovering from failure.

20. The method according to claim 19, further comprising:
designating the secondary task-specific master keys as primary task-specific master keys; and
providing new secondary task-specific master keys to the nodes.

21. The method according to claim 18, further comprising triggering use of secondary task-specific master keys by the nodes upon one of the nodes depleting initialization vector space.

22. The method according to claim 21, further comprising:
designating the secondary task-specific master keys as primary task-specific master keys; and
providing new secondary task-specific master keys to the nodes.

23. The method according to claim 18, wherein the computing includes computing task-and-node-specific communication keys based on the task-specific master keys and a generation indicator.

24. The method according to claim 23, further comprising:
tracking the generation indicator of each of the nodes;
advancing a value of the generation indicator of a given node that recovered from failure; and
informing respective ones of the nodes about the value of the generation indicator of the given node.

25. The method according to claim 17, wherein:
the computing includes computing the task-and-node-specific communication keys based on the task-specific master keys and based on data that identifies a sender node;
receiving encrypted data from the sender node;
computing a decryption key based on a given one of the task master keys and the data that identifies the sender node; and
decrypting the encrypted data based on the decryption key.
